(19) United States
(12) Patent Application Publication
(10) Pub. No.: US 2023/0393863 A1
(43) Pub. Date: Dec. 7, 2023

(54) SYSTEM AND METHOD FOR INTEGRATING NEW ARRANGEMENTS INTO ONE OR MORE SYSTEMS OF APPLICATIONS

(71) Applicant: CHEVRON U.S.A. INC., San Ramon, CA (US)

(72) Inventor: MATTHEW SCOTT BOLEN, San Ramon, CA (US)

(21) Appl. No.: 17/832,285

(22) Filed: Jun. 3, 2022

(51) Int. Cl. G06F 9/451; G06F 3/04817; G06F 3/0486

(52) U.S. Cl. CPC G06F 9/451; G06F 3/04817; G06F 3/0486

(57) ABSTRACT

The present disclosure relates generally to a system and method for rearranging a first system of software applications into a second system of software applications. The system includes a user device, a network, a data storage unit, and a server. The user device can display a first system of applications. The user can offer a number of rearrangements by clicking and dragging the applications and connections points to their desired positions. A predictive model can produce a second system of applications based on these rearrangements.

### FIELD OF THE DISCLOSURE

The present disclosure relates to integrating new arrangements of software applications using a user interface and display.

### BACKGROUND

A system of computer applications must often be rearranged or otherwise changed in order to achieve a certain goal or increase efficiency. For example, a user may want to connect a data storage unit to Application #1 and Application #2. To do so, the user must form a new connection point between the two applications and the data storage unit. But to accomplish this, the user often must perform the time consuming task of re-programming the system of applications. Because new problems in the technological space demand swift and efficient solutions, there is a need for a system and method to quickly rearrange an application system.

These and other deficiencies exist. Therefore, there is a need to provide a system and method that overcome these deficiencies.

### SUMMARY OF THE DISCLOSURE

Aspects of the disclosed embodiments include a system, method, and a computer readable non-transitory medium.

Embodiments of the present disclosure provide a method comprising the steps of displaying, by a user device, a visual system comprising a first system of applications. Then, the method proceeds with arranging, by the user device, the first system of applications, the arrangement comprising at least one selected from the group of an addition of a connection point, a deletion of a connection point, and an amendment to an connection point, a connection point comprising a relationship between one or more applications. Then, the method proceeds with integrating, by a server, the arrangements into a second system of applications. Next, the server can transmit a suggestion for missing information. Then, the user device can display the second system of applications.

Embodiments of the present disclosure also provide a system comprising: a server; a data storage unit; and a user device configured to display a visual system comprising a first system of applications. Next, the user device can arrange the first system of applications, the arrangement comprising at least one selected from the group of an addition of a connection point, a deletion of a connection point, and an amendment to an connection point. Next, the server can integrate the arrangements into a second system of applications. Then, the server can receive a suggestion for missing information. Next, the user device can display a second system of applications.

Embodiments of the present disclosure also provide a computer readable non-transitory medium comprising computer executable instructions that, when executed on a processor, perform procedures comprising the steps of displaying a visual system comprising a first system of applications. Next, the processor can arrange the first system of applications, the arrangement comprising at least one selected from the group of an addition of a connection point, a deletion of a connection point, and an amendment to an connection point. Next, the processor can integrate the arrangements into a second system of applications and receive a suggestion for missing information. Then, the processor can display a second system of applications.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates a system according to an exemplary embodiment.

FIG. 2 is a block diagram illustrating a system according to an exemplary embodiment.

FIG. 3a-3b are block diagrams illustrating a system according to an exemplary embodiment.

FIG. 4 is a flowchart illustrating a system according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present embodiments generally disclose a system for rearranging a system of applications on a user device. A user device displays a system of applications on a screen or other display. The system can include one or more types of applications such as software, middleware, data storage units, and other kinds of applications. Between some applications can be at least one connection point. A connection point may be connection, relationship, or some other pathway between one or more applications. As an example, a connection point may be a read or write relationship between two applications. As another example, a connection point may be pathway for storing one or more data steps from an application into a data storage unit. The user device can display these applications and connection points as a one or more symbols. For example, the applications can be presented as squares, and the connection points can be represented as arrows connecting the applications together.

To rearrange or otherwise change the system of applications, the user can click and drag via a computer mouse, touchpad, or touchscreen the connection points between the applications. Additionally, the user can interact with the applications themselves. As an example, the user may click a connection point currently connecting Application #1 and Application #2, then drag the connection such that the connection point connection Application #1 and the data storage unit. Alternatively, the user may arrangement the connection point such that both applications are connected to the data storage unit.

This system of rearranging a system of applications is quick and intuitive. Rather than perform some backend programming procedure, a user may simply click and drag connection points between one or more applications. This saves the user time and frustration.

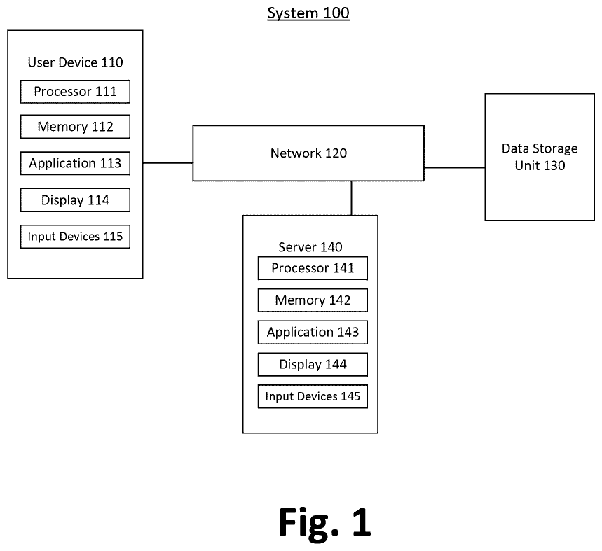

FIG. 1 illustrates a block diagram of a system according to an exemplary embodiment.

FIG. 1 is a block diagram according to an exemplary embodiment. FIG. 1 illustrates a system 100 according to an example embodiment. The system 100 may comprise a user device 110, a network 120, a data storage unit 140, and a server 140. Although FIG. 1 illustrates single instances of components of system 100, system 100 may include any number of components.

System 100 may include a user device 110. The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 120 may include a processor 111, a memory 112, and an application 113. The processor 111 may be a processor, a microprocessor, or other processor, and the user device 110 may include one or more of these processors. The processor 111 may include processing circuitry, which may comprise additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may often not be rewritten, but it may be read many times. A read/write memory may be programmed and re-programed many times after leaving the factory. It may also be read many times. The memory 112 may be configured to store one or more software applications, such as the application 113, and other data, such as user's private data and other information.

The application 113 may comprise one or more software applications, such as a mobile application and a web browser, comprising instructions for execution on the user device 110. In some examples, the user device 110 may execute one or more applications, such as software applications, that enable, for example, network communications with one or more components of the system 100, transmit and/or receive data, and/or perform the functions described herein. Upon execution by the processor 111, the application 113 may provide the functions described in this specification, specifically to execute and perform the steps and functions in the process flows described below. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touchscreen, keyboard, mouse, cursor-control device, microphone, digital camera, video recorder or camcorder. These devices may be used to enter information and interact with the software and other devices described herein.

System 100 may include one or more networks 120. In some examples, the network 120 may be one or more of a wireless network, a wired network or any combination of a wireless network and a wired network and may be configured to connect the user device 110, the server 140, and the data storage unit 140. For example, the network 120 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 120 may include, without limitation, telephone lines, fiber optics, IEEE Ethernet 902.3, a wide area network, a wireless personal area network, a LAN, or a global network such as the Internet. In addition, the network 120 may support an Internet network, a wireless communication network, a cellular network, or the like, or any combination thereof. The network 120 may further include one network, or any number of the exemplary types of networks mentioned above, operating as a stand-alone network or in cooperation with each other. The network 120 may utilize one or more protocols of one or more network elements to which they are communicatively coupled. The network 120 may translate to or from other protocols to one or more protocols of network devices. Although the network 120 is depicted as a single network, it should be appreciated that according to one or more examples, the network 120 may comprise a plurality of interconnected networks, such as, for example, the Internet, a service provider's network, corporate networks, and home networks. The network 120 may further comprise, or be configured to create, one or more front channels, which may be publicly accessible and through which communications may be observable, and one or more secured back channels, which may not be publicly accessible and through which communications may not be observable.

System 100 may include a data storage unit 130. The data storage unit 130 may be one or more data storage units configured to store technical or other data, including without limitation, private data of users or operators, accounts of users or operators, identities of users or operators, and certified and uncertified documents. The data storage unit 130 may comprise a relational data storage unit, a non-relational data storage unit, or other data storage unit implementations, and any combination thereof, including a plurality of relational data storage units and non-relational data storage units. In some examples, the data storage unit 130 may comprise a desktop data storage unit, a mobile data storage unit, or an in-memory data storage unit. Further, the data storage unit 130 may be hosted internally by the server 140 or may be hosted externally of the server 140, such as by a server, by a cloud-based platform, or in any storage device that is in data communication with the server 140.

System 100 may include a server 140. The server 140 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 140 may include a processor 141, a memory 142, and an application 143. The processor 141 may be a processor, a microprocessor, or other processor, and the server 140 may include one or more of these processors. The processor 141 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 141 may be coupled to the memory 142. The memory 142 may be a read-only memory, write-once read-multiple memory or read/write memory, e.g., RAM, ROM, and EEPROM, and the server 140 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it often may not be rewritten, but it may be read many times. A read/write memory may be programmed and re-programed many times after leaving the factory. It may also be read many times. The memory 142 may be configured to store one or more software applications, such as the application 143, and other data, such as user's private data and account information.

The application 143 may comprise one or more software applications comprising instructions for execution on the server 140. In some examples, the server 140 may execute one or more applications, such as software applications, that enable, for example, network communications with one or more components of the system 100, transmit and/or receive data, and perform the functions described herein. Upon execution by the processor 141, the application 143 may provide the functions described in this specification, specifically to execute and perform the steps and functions in the process flows described below. For example, the application 143 may be executed to perform receiving web form data from the user device 120 and the storage device 160, retaining a web session between the user device 120 and the storage device 160, and masking private data received from the user device 120 and the storage device 160. Such processes may be implemented in software, such as software modules, for execution by computers or other machines. The application 143 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 140 may further include a display 144 and input devices 145. The display 144 may be any type of device for presenting visual information such as a computer monitor, a flat panel display, and a mobile device screen, including liquid crystal displays, light-emitting diode displays, plasma panels, and cathode ray tube displays. The input devices 145 may include any device for entering information into the server 140 that can be available and supported by the server 140, such as a touchscreen, keyboard, mouse, cursor-control device, microphone, digital camera, video recorder or camcorder. These devices may be used to enter information and interact with the software and other devices described herein.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the contactless card 110, the user device 120, the server 140, the network 140, and the data storage unit 130 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

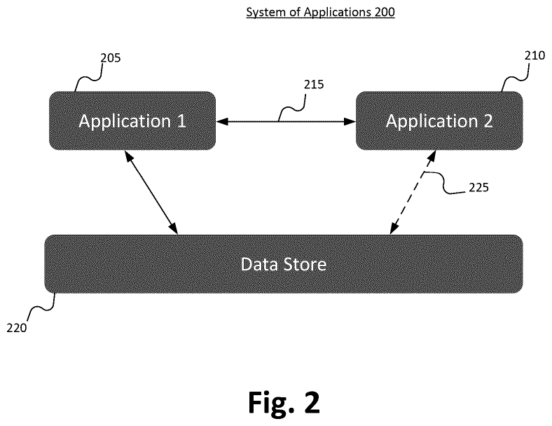

FIG. 2 is a block diagram illustrating a system of applications according to an exemplary embodiment.

The system of applications 200 can include one or more web applications, mobile applications, or some other computer-enabled applications. The applications can include without limitation processing applications, middleware, and data stores and data lakes. The applications may be displayed on a screen or some other display associated with a user device. Each application can be visually represented by a block or some other shape, such as the blocks 205 and 210. Though FIG. 2 depicts the applications as rectangles, it is understood that the applications may be represented by some other shape. Between each application there can exists one or more connection points. A connection point is a relationship such as read/write or read only. A connection point can be preexisting such as connection point 215, or it can be created or edited by the user such as the connection point 225. As a nonlimiting example, Application 1 and Application 2 can share a connection point, and the data store 220 can share two connection points with Applications 1 and 2.

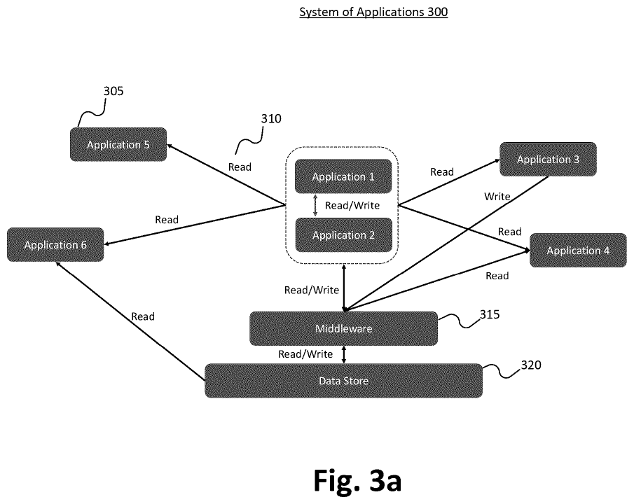

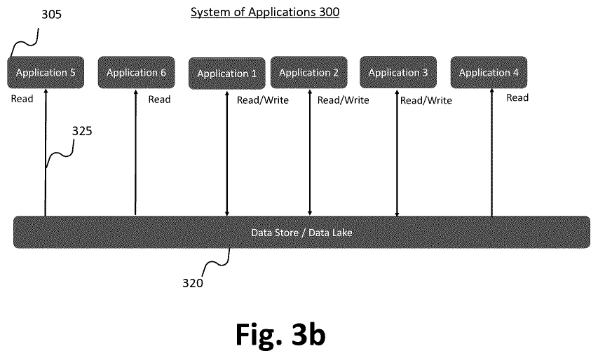

FIG. 3a is a block diagram illustrating a first system of applications.

The system of applications 300 represents a first system of applications. Because this system is sprawling and somewhat disorganized, a user might desire to rearrange the system to improve efficiency. The one or more applications 305 are connected by one more connection points 310. Other applications can include middleware 315 and a data store 320.

FIG. 3b is a block diagram illustrating a second system of applications.

The system of applications 300 can be rearranged into a second system of applications. The user may use the touchpad, touchscreen, or mouse to interact with virtual items on the screen. Here, the system of applications has been streamlined to be more organized. That is, the amount of overlapping or gratuitous connections points 325 has been limited between the apps 305 and the data store or data lakes 320.

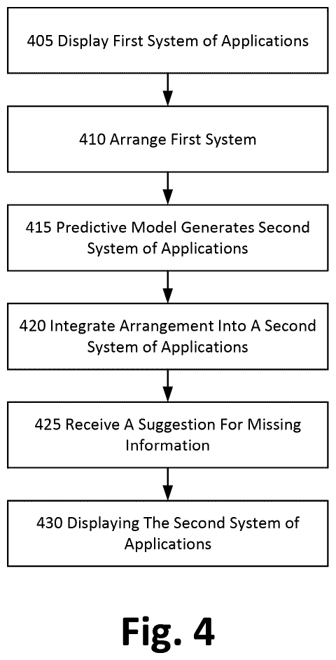

FIG. 4 is a flowchart illustrating a method according to an exemplary embodiment.

In action 405, the first system of applications can be displayed. This action can be performed by a user device or user interface. The user device is discussed with further reference to FIG. 1. In addition to the display, the user device can be touchpad, touchscreen, or mouse capable. The user may use the touchpad, touchscreen, or mouse to interact with virtual items on the screen. In action 410, the first system can be arranged or rearranged. The arrangement can include any interaction with the virtual objects on the screen. The virtual objects can represent — literally or metaphorically—one or more mobile applications or web applications. The web applications can have a relationship with each other represented by a connection point. The connection point can be represented visually as a line, arrow, or some connecting visual cue between the virtual objects. The connection point can represent one or more relationships between applications. Each arrangement can comprise a discreet action. As a nonlimiting example, an arrangement can include an addition of a connection point, a deletion of a connection point, and an amendment to an connection point, a connection point comprising a relationship between one or more applications. Upon making one or more arrangement to the first system of applications, in action 415 a predictive model generates second system of applications. The predictive model can be associated with the user device or the server. As an example, the user device can transmit the one or more arrangements to the server over a wired or wireless network. In action 420, the arrangements made by the user device can be integrated into the second system of applications. In action 425, the user device can receive a suggestion for missing information. The suggestion can be generated by the predictive model. In action 430, the user device can display the second system of applications.

As a nonlimiting example, the predictive model can be a machine learning model or a neural network. The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-readable medium can utilize various neural networks, such as convolutional neural networks (CNNs) or recurrent neural networks (RNNs), to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

What is claimed is:

1. A method comprising the steps of:
displaying, by a user device, a system comprising a first system of applications;
arranging, by the user device, the first system of applications, the arrangement comprising at least one selected from the group of an addition of a connection point, a deletion of a connection point, and an amendment to a connection point, a connection point comprising a relationship between one or more applications;
integrating, by a server, the arrangements into a second system of applications;
receiving, from a server, a suggestion for missing information; and
displaying, by the user device, the second system of applications.

2. The method of claim 1, wherein the one or more arrangements further comprise changing a read-only application to a read-write application and changing a read-write application to a read-only application

3. The method of claim 1, wherein the first and second system and application comprise a data store, data lake, or middleware applications.

4. The method of claim 1, wherein the server further comprises a predictive model configured to generate the second system of application according to the arrangements.

6. The method of claim 1, wherein the arrangement can be performed by the user clicking and dragging the connections points from one application to another.

7. A system comprising:
a server;
a data storage unit; and
a user device configured to:
displaying, by a user device, a visual system comprising a first system of applications;
arranging, by the user device, the first system of applications, the arrangement comprising at least one selected from the group of an addition of a connection point, a deletion of a connection point, and an amendment to an connection point;
integrating, by the server, the arrangements into a second system of applications;
receiving, from a server, a suggestion for missing information; and
displaying, by the user device, a second system of applications.

8. The system of claim 5, wherein the server further comprises a predictive model configured to generate the second system of application according to the arrangements.

9. A computer readable non-transitory medium comprising computer executable instructions that, when executed on a processor, perform procedures comprising the steps of:
displaying a visual system comprising a first system of applications;
arranging the first system of applications, the arrangement comprising at least one selected from the group of an addition of a connection point, a deletion of a connection point, and an amendment to an connection point;
integrating the arrangements into a second system of applications;
receiving a suggestion for missing information; and
displaying a second system of applications.
